(19) United States
(12) Patent Application Publication
(10) Pub. No.: US 2022/0012921 A1
(43) Pub. Date: Jan. 13, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/149,728

(22) Filed: Jan. 15, 2021

(30) Foreign Application Priority Data
Jul. 7, 2020 (JP) 2020-117288

(51) Int. Cl. G06T 11/00

(52) U.S. Cl. CPC G06T 11/00

(57) ABSTRACT

An information processing apparatus includes a processor configured to cause a display to display a first image that represents a present situation with a second image related to an object in a previous situation as superposed on the first image.

### CROSS-REFERENCE TO RELATED APPLICATIONS

This application is based on and claims priority under 35 USC 119 from Japanese Patent Application No. 2020-117288 filed Jul. 7, 2020.

### BACKGROUND

### (i) Technical Field

The present disclosure relates to an information processing apparatus and a non-transitory computer readable medium.

### (ii) Related Art

Japanese Unexamined Patent Application Publication No. 2013-228311 describes a navigation system that displays a plurality of pieces of information as superimposed on each other using augmented reality technology to provide guidance on a route.

Japanese Unexamined Patent Application Publication No. 2013-183333 describes a device that displays a regenerated visual image and displays an augmented reality (AR) tag represented by AR data at a position at which a coordinate represented by display AR data obtained from a travel history of a vehicle is captured.

### SUMMARY

The situation of an object such as a substance installed in a space and an image displayed on a display at a previous time point is occasionally varied.

Aspects of non-limiting embodiments of the present disclosure relate to informing a user of a previous situation of an object at the same time as the present situation thereof.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to cause a display to display a first image that represents a present situation with a second image related to an object in a previous situation as superposed on the first image.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to the present exemplary embodiment;

FIG. 2 is a block diagram illustrating the configuration of an information processing apparatus;

FIG. 3 is a block diagram illustrating the configuration of a terminal apparatus;

FIG. 4 illustrates an image database;

FIG. 5 illustrates a previous image;

FIG. 6 illustrates a present image;

FIG. 7 illustrates an image that represents the present situation and the previous situation;

FIG. 8 illustrates an image that represents the present situation and the previous situation;

FIG. 9 illustrates an image that represents the present situation and the previous situation;

FIG. 10 illustrates a screen;

FIG. 11 illustrates a screen;

FIG. 12 illustrates a screen;

FIG. 13 illustrates the screen; and

FIG. 14 illustrates the screen.

### DETAILED DESCRIPTION

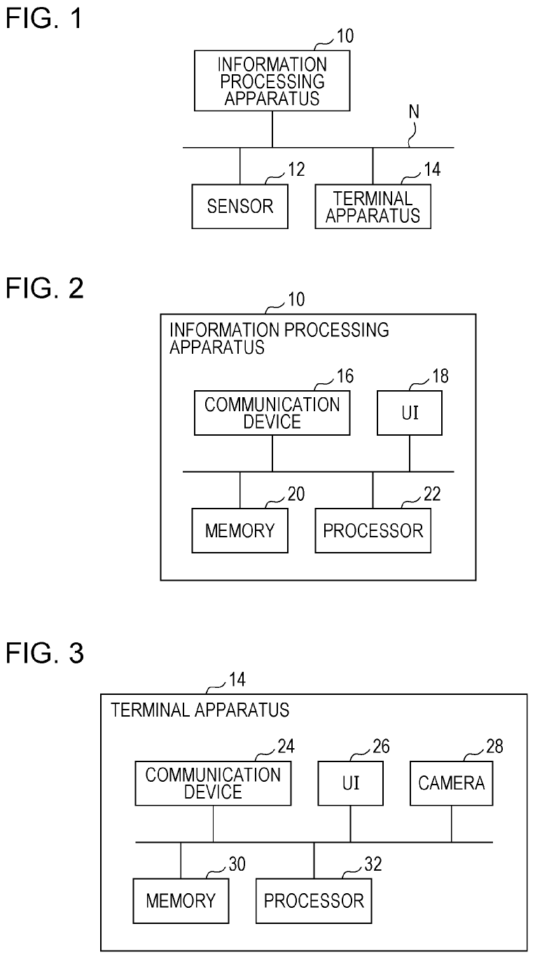

An information processing system according to the present exemplary embodiment will be described with reference to FIG. 1. FIG. 1 illustrates an example of the configuration of the information processing system according to the present exemplary embodiment.

The information processing system according to the present exemplary embodiment includes an information processing apparatus 10, one or more sensors 12, and one or more terminal apparatuses 14.

The information processing apparatus 10, the sensors 12, and the terminal apparatuses 14 have a function to communicate with a different device or a different sensor. The communication may be made through wired communication in which a cable is used, or may be made through wireless communication. That is, the devices and the sensors may be physically connected to a different device through a cable to transmit and receive information to and from each other, or may transmit and receive information to and from each other through wireless communication. Examples of the wireless communication include near-field wireless communication and Wi-Fi (registered trademark). Wireless communication of a different standard may also be used. Examples of the near-field wireless communication include Bluetooth (registered trademark), Radio Frequency Identifier (RFID), and Near Field Communication (NFC). The devices may communicate with a different device via a communication path N such as a Local Area Network (LAN) and the Internet, for example.

In the information processing system according to the present exemplary embodiment, an image (hereinafter referred to as a “first image”) that represents the present situation is displayed on a display with an image (hereinafter referred to as a “second image”) related to an object in a previous situation superposed thereon.

The object may be a tangible object, or may be an intangible object.

Examples of the tangible object include a physical substance disposed in the actual space. The tangible object is not specifically limited. Examples of the tangible object include a device, a tool, a stationery item, a writing instrument, a household item, a cooking utensil, a sports instrument, a medical instrument, a farming tool, a fishing tool, an experimental instrument, and other physical things. The device is not specifically limited. Examples of the device include a personal computer (hereinafter referred to as a “PC”), a tablet PC, a smartphone, a cellular phone, a robot (such as a humanoid robot, a non-humanoid animal-like robot, and other robots), a printer, a scanner, a multi-function device, a projector, a display device such as a liquid crystal display, a recording device, a playback device, an imaging device such as a camera, a refrigerator, a rice cooker, a microwave oven, a coffee maker, a vacuum cleaner, a washing machine, an air conditioner, lighting equipment, a clock, a monitoring camera, an automobile, a two-wheeled vehicle, an aircraft (e.g. an unmanned aircraft (a so-called drone)), a gaming device, and various sensing devices (e.g. a temperature sensor, a humidity sensor, a voltage sensor, a current sensor, etc.). The device may be an information device, a visual device, or an audio device.

Examples of the intangible object include an image (e.g. a still image and a moving image) displayed on the display and a character string. The image is not specifically limited. The image may be an image captured and generated by a capture device such as a camera, may be an icon connected with a specific function, or may be an image related to a specific operation.

The information processing apparatus 10 is a device configured to manage images. For example, images are captured and generated by the sensors 12, the terminal apparatuses 14, and other devices, and transmitted to the information processing apparatus 10. The information processing apparatus 10 manages the images. In another example, images displayed on the display are transmitted to the information processing apparatus 10, and the information processing apparatus 10 manages the images. The information processing apparatus 10 manages the images chronologically, for example.

The second image may be an image (e.g. an image or an icon that represents a substance, etc.) that represents an object itself, or may be an image (e.g. an image of an arrow that indicates a substance or an icon, etc.) that provides guidance on an object. For example, an image that represents a substance itself may be extracted from an image captured and generated by the sensor 12, the terminal apparatus 14, etc., and the extracted image may be managed as the second image. Alternatively, an icon may be extracted from an image displayed on the display, and the extracted icon may be managed as the second image.

The sensor 12 is a device that has a function to detect a tangible object disposed in a space. Examples of the sensor 12 include a camera, an infrared sensor, and an ultrasonic sensor. For example, a tangible object disposed in a space is captured by a camera, and a still image and a moving image generated through the capture are transmitted from the camera to the information processing apparatus 10 to be managed by the information processing apparatus 10.

The space in which the tangible object is disposed may be a closed space, or may be an open space. Examples of the space include a booth, a meeting room, a shared room, an office such as a shared office, a classroom, a store, an open space, and other defined locations.

Examples of the terminal apparatus 14 include a PC, a tablet PC, a smartphone, and a cellular phone. The terminal apparatus 14 may be a device (e.g. a wearable device) to be worn by the user. The wearable device may be a glass-type device, a contact lens-type device to be worn on an eye, a head mounted display (HMD), or a device (e.g. an ear-wearable device) to be worn on an ear.

The hardware configuration of the information processing apparatus 10 will be described below with reference to FIG. 2. FIG. 2 illustrates an example of the hardware configuration of the information processing apparatus 10.

The information processing apparatus 10 includes a communication device 16, a user interface (UI) 18, a memory 20, and a processor 22, for example.

The communication device 16 is a communication interface that includes a communication chip, a communication circuit, etc., and has a function of transmitting information to a different device and a function of receiving information transmitted from a different device. The communication device 16 may have a wireless communication function, or may have a wired communication function. The communication device 16 may communicate with a different device by using near-field wireless communication, or may communicate with a different device via a communication path such as a LAN or the Internet, for example.

The UI 18 is a user interface, and includes at least one of a display and an operation device. The display may be a display device such as a liquid crystal display or an electro-luminescence (EL) display. The operation device may be a keyboard, an input key, an operation panel, etc. The UI 18 may be a UI that serves as both the display and the operation device such as a touch screen. The information processing apparatus 10 may not include the UI 18.

The memory 20 is a device that constitutes one or more storage areas that store various kinds of information. Examples of the memory 20 include a hard disk drive, various types of memories (e.g. a RAM, a DRAM, a ROM, etc.), other storage devices (e.g. an optical disk etc.), and a combination thereof. One or more memories 20 are included in the information processing apparatus 10.

The memory 20 stores image management information for managing images. The image management information includes images, date/time information that indicates the date and time when the images were obtained, location information that indicates the location at which the images were obtained, object identification information for identifying objects represented in the images, etc., for example.

The processor 22 is configured to control operation of various portions of the information processing apparatus 10. The processor 22 may include a memory.

For example, the processor 22 receives images, and stores the images in the memory 20 to manage the images. In addition, the processor 22 executes a process of displaying a second image as superposed on a first image. For example, the processor 22 displays a previous image as superposed on an actual image by using augmented reality (AR) technology or mixed reality (MR) technology. The first image may be captured and generated by a camera which is an example of the sensor 12, or may be captured and generated by the terminal apparatus 14.

The hardware configuration of the terminal apparatus 14 will be described below with reference to FIG. 3. FIG. 3 illustrates an example of the hardware configuration of the terminal apparatus 14.

The terminal apparatus 14 includes a communication device 24, a UI 26, a camera 28, a memory 30, and a processor 32, for example.

The communication device 24 is a communication interface that includes a communication chip, a communication circuit, etc., and has a function of transmitting information to a different device and a function of receiving information transmitted from a different device. The communication device 24 may have a wireless communication function, or may have a wired communication function. The communication device 24 may communicate with a different device by using near-field wireless communication, or may communicate with a different device via a communication path such as a LAN or the Internet, for example.

The UI 26 is a user interface, and includes at least one of a display and an operation device. The display may be a display device such as a liquid crystal display or an electro-luminescence (EL) display. The operation device may be a keyboard, an input key, an operation panel, etc. The UI 26 may be a UI that serves as both the display and the operation device such as a touch screen. The UI 26 may include a microphone and a speaker.

The camera 28 is an example of a capture device that has a function to capture and generate a still image and a moving image.

The memory 30 is a device that constitutes one or more storage areas that store various kinds of information. Examples of the memory 30 include a hard disk drive, various types of memories (e.g. a RAM, a DRAM, a ROM, etc.), other storage devices (e.g. an optical disk etc.), and a combination thereof. One or more memories 30 are included in the terminal apparatus 14.

The processor 32 is configured to control operation of various portions of the terminal apparatus 14. The processor 32 may include a memory.

For example, the processor 32 causes the display of the UI 26 to display an image. The processor 32 causes the display to display an image captured and generated by the camera 28 or the sensor 12, causes the display to display the second image, or causes the display to display the first image and the second image in the state of being superposed on each other. In addition, the processor 32 may execute some or all of the processes performed by the processor 22 of the information processing apparatus 10. For example, the processor 32 may execute a process of displaying the second image as superposed on the first image which is captured by the camera 28. The processor 32 may display the second image as superposed on the first image by using the AR technology or the MR technology.

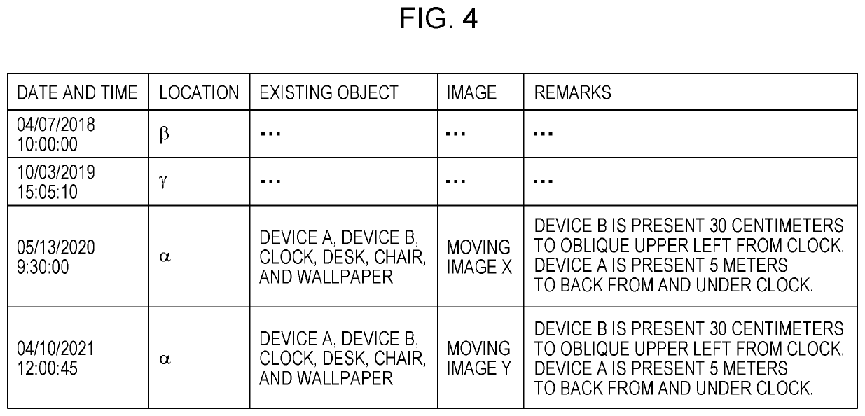

The image management information which is stored in the information processing apparatus will be described in detail below with reference to FIG. 4. FIG. 4 illustrates an example of an image database. The image database is an example of the image management information.

In the image database, each image is connected with date/time information that indicates the date and time when the image was obtained, location information that indicates the location at which the image was obtained, object identification information for identifying objects represented in the image, the image, and remarks information. Upon receiving an image from the sensor 12, the terminal apparatus 14, or a different device, the processor 22 of the information processing apparatus 10 registers the image in the image database.

Here, by way of example, the object is a tangible object (existing object in FIG. 4) that exists in the actual space. The “location” which is managed in the situation management database is the location at which the tangible object as the object is disposed. The “image” which is managed in the situation management database is an image captured at the location and generated by the sensor 12, the terminal apparatus 14, or a different device. The “existing object” is a tangible object that exists at the location and that is represented in the image. The “date and time” which is managed in the situation management database is the data and time when the image was captured. In the example illustrated in FIG. 4, the situation of a tangible object is managed. However, the situation of an intangible object may be managed.

For example, capture is performed at a location α at 09:30:00 on May 13, 2020, and a moving image X is generated and registered in the situation management database. In addition, capture is performed at the location α on a date and time (12:00:45 on Apr. 10, 2021) that is different from the data and time when the moving image X is captured, and a moving image Y is generated and registered in the situation management database. The moving images X and Y include a device A, a device B, a clock, a desk, a chair, and wallpaper as examples of the existing object. In this manner, moving images that represent the situation at the location α are managed chronologically.

Here, by way of example, the moving images X and Y which represent the location α are generated by capturing the location α using the camera 28 of the terminal apparatus 14. The moving image X and the date/time information which indicates the date and time of the capture are transmitted from the terminal apparatus 14 to the information processing apparatus 10, and registered in the situation management database. The same also applies to the moving image Y.

The terminal apparatus 14 may acquire position information on the terminal apparatus 14 by using a global positioning system (GPS). For example, the terminal apparatus 14 acquires position information on the terminal apparatus 14 at the time when the moving image X is captured. The position information is transmitted from the terminal apparatus 14 to the information processing apparatus 10 as information accompanying the moving image X, and registered in the situation management database in connection with the moving image X. For example, the position information is included in the location information which indicates the location α. The location information which indicates the location α at which capture was performed may be input to the terminal apparatus 14 by the user operating the terminal apparatus 14. In this case, the location information which is input by the user is transmitted from the terminal apparatus 14 to the information processing apparatus 10, and registered in the situation management database in connection with the moving image X. The same also applies to the moving image Y.

The terminal apparatus 14 may include a sensor such as an acceleration sensor, an angular speed sensor, or a geomagnetic sensor, and acquire orientation information that indicates the direction or the orientation of the terminal apparatus 14. For example, the terminal apparatus 14 acquires orientation information on the terminal apparatus 14 at the time when the moving image X was captured. The orientation information is transmitted from the terminal apparatus 14 to the information processing apparatus 10 as information accompanying the moving image X, and registered in the situation management database in connection with the moving image X. For example, the orientation information is included in the location information which indicates the location α. The same also applies to the moving image Y.

An existing object may be automatically extracted from each of the moving images X and Y, or may be designated by the user. For example, the processor 22 of the information processing apparatus 10 recognizes an existing object represented in each of the moving images X and Y by applying a known image recognition technique or image extraction technique to each of the moving images X and Y. For example, an existing object to be recognized is determined in advance, and the processor 22 of the information processing apparatus 10 recognizes the existing object determined in advance from each of the moving images X and Y. In the case where information that indicates the name of an existing object, information that indicates the function of an existing object, etc. is registered in advance in a database etc., the processor 22 of the information processing apparatus 10 may acquire information that indicates the name or the function of an existing object recognized from each of the moving images X and Y from the database etc., and register such information in the situation management database. The processor 32 of the terminal apparatus 14 may recognize an existing object from each of the moving images X and Y.

The user may designate an existing object. For example, the user designates an existing object to be registered in the situation management database, from among one or more tangible objects represented in the moving image X, by operating the terminal apparatus 14 when or after the moving image X is captured. Specifically, the processor 32 of the terminal apparatus 14 causes the display of the terminal apparatus 14 to display the moving image X, and the user designates an existing object to be registered in the situation management database on the displayed moving image X. Information that indicates the existing object designated by the user is transmitted from the terminal apparatus 14 to the information processing apparatus 10, and registered in the situation management database. The same also applies to the moving image Y.

The processor 32 of the terminal apparatus 14 may recognize one or more tangible objects represented in the moving image X by applying an image recognition technique, an image extraction technique, etc. to the moving image X. In this case, the user may designate an existing object to be registered in the situation management database from the one or more recognized tangible objects by operating the terminal apparatus 14. Information that indicates the existing object designated by the user is transmitted from the terminal apparatus 14 to the information processing apparatus 10, and registered in the situation management database. The same also applies to the moving image Y.

The situation management database also includes the remarks information. Examples of the remarks information include information that indicates the position of an existing object at the location. For example, the remarks information includes information that indicates the relative position from a reference position determined using the position of a reference object determined in advance as the reference. In a specific example, information indicating that the device B is present 30 centimeters to the oblique upper left from the clock which is determined as the reference object and that the device A is present five meters to the back from and under the clock is connected with each of the moving images X and Y as the remarks information. The reference object may be designated by the user, or may be determined in advance not by the user, for example.

For example, the processor 22 of the information processing apparatus 10 or the processor 32 of the terminal apparatus 14 may specify the relative position of each existing object from the position of the reference object by analyzing the moving image X. The user may input information that indicates the relative position of each existing object from the position of the reference object by operating the terminal apparatus 14. The same also applies to the moving image Y.

Information on ambient sounds obtained when an image is captured or environment information (e.g. information on the air temperature, humidity, atmospheric pressure, etc.) may be measured, and such information may be included in the remarks information.

The process performed by the information processing system according to the present exemplary embodiment will be described in detail below.

### Process Performed in Case Object is Substance

A process performed in the case where the object is a substance will be described below.

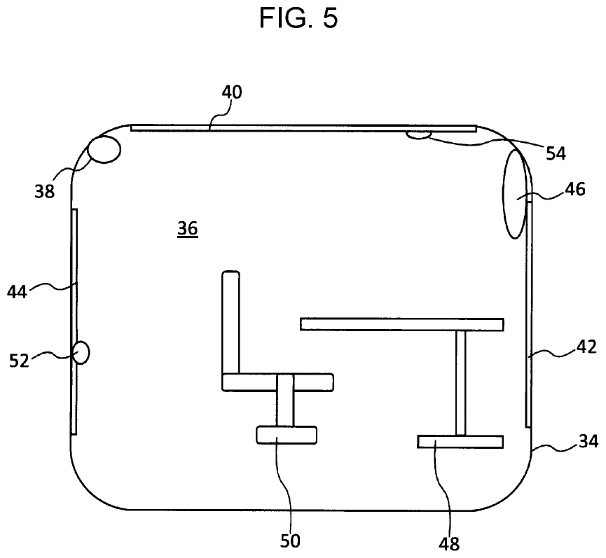

A previous image will be described with reference to FIG. 5. FIG. 5 illustrates an example of the previous image. For example, an image 34 that represents the location α which is a space 36 is generated by the camera 28 of the terminal apparatus 14 capturing the location α at a certain previous time point. The image 34 may be a still image, or may be a moving image. In addition, the terminal apparatus 14 acquires position information and orientation information on the terminal apparatus 14 at the time when the image 34 was captured, and connects such information with the image 34. Here, by way of example, the location α is a room.

For example, the camera 38, wallpaper 40, 42, and 44, a clock 46, a desk 48, a chair 50, and devices 52 and 54 are disposed at the location α, and such substances are represented in the image 34. These substances (e.g. the device 52 etc.) are disposed so as to be seeable from the outside at the time point when the image 34 is captured. At a later time point, however, the substances may be made unseeable from the outside by attaching a cover etc.

The image 34, date/time information that indicates the date and time when the image 34 is captured, and location information (information that includes position information and orientation information on the terminal apparatus 14 at the time when the image 34 is captured) that indicates the location α are transmitted from the terminal apparatus 14 to the information processing apparatus 10, and registered in the image database. For example, in the case where the terminal apparatus 14 is located at the location α (e.g. in the case where the user who owns the terminal apparatus 14 stays at the location α), the location α at which the user stays may be specified on the basis of the position information on the terminal apparatus 14, and information that indicates the name etc. of the location α may be included in information that indicates the location α. For example, the position information and the information which indicates the name etc. of the location α are connected in advance with each other, and managed by the information processing apparatus 10, a server, etc., and the name etc. of the location α is specified on the basis of the position information on the terminal apparatus 14. The specifying process is performed by the information processing apparatus 10, the terminal apparatus 14, a server, etc., for example. In the case where the user inputs the name etc. of the location α to the terminal apparatus 14, information that indicates the name etc. of the location α may be included in the information which indicates the location α.

Here, by way of example, the clock 46 is determined as the reference object. The image 34 may be displayed on the display of the UI 26 of the terminal apparatus 14, and the user may designate the clock 46 as the reference object on the displayed image 34. In another example, the processor 22 of the information processing apparatus 10 or the processor 32 of the terminal apparatus 14 may recognize the clock 46 as the reference object from the image 34. The designated or recognized clock 46 is registered in the image database as the reference object in connection with the image 34.

The user may designate an existing object to be registered in the image database. For example, the image 34 is displayed on the display of the UI 26 of the terminal apparatus 14, and the user designates an existing object to be registered on the displayed image 34. For example, when the wallpaper 40, 42, and 44, the clock 46, the desk 48, the chair 50, and the devices 52 and 54 are designated by the user, such designated existing objects are registered in the image database. In another example, the processor 22 of the information processing apparatus 10 or the processor 32 of the terminal apparatus 14 may extract, from the image 34, existing objects determined in advance as existing objects to be registered in the situation management database, and register the extracted existing objects in the image database.

An image of the device 52 is an example of the second image related to the device 52 in a previous situation, and is an example of the second image related to the device 52 which was disposed at the location α at a previous time point (i.e. at the time point when the image 34 was captured). The same also applies to images of the other existing objects.

For example, the processor 22 of the information processing apparatus 10 or the processor 32 of the terminal apparatus 14 extracts an image of the device 52 from the image 34. The same also applies to images of the other existing objects. A known image extraction technique may be used, for example. For example, an existing object to be extracted is determined in advance, and the existing object determined in advance is extracted from the image 34. For example, in the case where the device 52 is determined as an existing object to be extracted and the desk 48 and the chair 50 are not determined as an existing object to be extracted, an image of the device 52 is extracted, and images of the desk 48 and the chair 50 are not extracted. The same also applies to the other existing objects.

The information that indicates the name of an existing object, information that indicates the function of an existing object, etc. described above may be registered in the situation management database in connection with the image 34. The name and the function of each existing object may be designated by the user, or may be specified on the basis of information registered in a database etc.

The image 34 may be registered in the situation management database in the case where the user provides an instruction to register the image by operating the terminal apparatus 14.

In another example, an image in which an existing object has been varied may be registered in the image database in the case where the existing object which is represented in the image is varied. For example, it is assumed that the location α is captured at a time point that is previous to the time point when the image 34 is captured, and that a different image generated by the capture is registered in the image database. In this case, the processor 22 of the information processing apparatus 10 receives the image 34 from the terminal apparatus 14, compares the different image and the image 34 which are generated by capturing the same location α, and analyzes the different image and the image 34 to determine whether or not an existing object represented in the image 34 has been varied. For example, in the case where the display position of an existing object represented in the image 34 has been varied from the display position of the existing object which is represented in the different image, the processor 22 determines that the existing object has been varied. In the case where an existing object displayed in the different image is not displayed in the image 34, meanwhile, the processor 22 determines that the existing object has been varied. In the case where an existing object not displayed in the different image is displayed in the image 34, meanwhile, the processor 22 determines that the existing object has been varied. In such cases, the processor 22 registers the image 34 which has been varied in the image database.

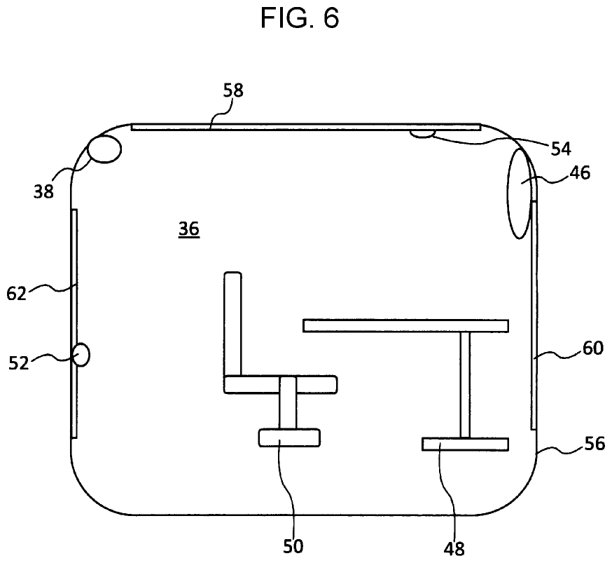

A present image will be described below with reference to FIG. 6. FIG. 6 illustrates an example of the present image. For example, an image 56 that represents the location α is generated by capturing the location α at the present time point using the camera 28 of the terminal apparatus 14. The image 56 may be a still image, or may be a moving image. In addition, the terminal apparatus 14 acquires position information and orientation information on the terminal apparatus 14 at the time when the image 56 was captured, and connects such information with the image 56. The image 56 is an example of the first image which represents the present situation at the location α. The image 56 may be registered in the image database, as with the image 34. In this case, the image 56 is treated as a previous image for images to be captured at future time points (i.e. images at future time points).

As discussed above, the image 56 may be registered in the image database in the case where the user provides an instruction for such registration, or the image 56 may be registered in the image database in the case where an existing object represented in the image 56 is varied from that at a previous time point (e.g. at the time point when the image 34 was captured).

For example, the camera 38, wallpaper 58, 60, and 62, a clock 46, a desk 48, a chair 50, and devices 52 and 54 are disposed at the location α, and such substances are represented in the image 56. When compared with the image 34 illustrated in FIG. 5, the wallpaper 40, 42, and 44 at the time when the image 34 was captured has been replaced with the wallpaper 58, 60, and 62.

For example, the image 56 is displayed on the display of the UI 26 of the terminal apparatus 14 to allow the user to recognize a tangible object represented in the image 56.

In addition, the processor 32 of the terminal apparatus 14 acquires a previous image (e.g. the image 34) at the location α from the information processing apparatus 10, and causes the display to display the image 34 as superposed on the image 56. For example, when the user provides an instruction for superposition by operating the terminal apparatus 14, the processor 32 of the terminal apparatus 14 causes the display to display the image 34 as superposed on the image 56. That is, in the case where a request to display an image is received from the user, the processor 32 displays the image 34. The processor 22 of the information processing apparatus 10 may receive the image 56 from the terminal apparatus 14, perform a process of superposing the image 34 on the image 56, and transmit the image 56 and the image 34 which have been processed to the terminal apparatus 14 to be displayed on the display of the terminal apparatus 14. In the case where a plurality of previous images related to the location α are registered in the image database, a previous image selected by the user may be superposed on the image 56, all the images may be superposed on the image 56, or an image (e.g. the most recent image or the oldest image) that meets a condition determined in advance may be superposed on the image 56.

The processor 22 of the information processing apparatus 10 or the processor 32 of the terminal apparatus 14 specifies the position and the orientation of the terminal apparatus 14 at the time when each of the images 34 and 56 was captured on the basis of the position information and the orientation information which are connected with each of the images 34 and 56, for example, and displays the image 34 as superposed on the image 56 with such positions and orientations coinciding with each other. For example, the image 34 is displayed as superposed on the image 56 by using the AR technology or the MR technology.

The processor 22 of the information processing apparatus 10 or the processor 32 of the terminal apparatus 14 may superpose all or a part of the image 34 on the image 56. For example, the second image which represents an existing object (e.g. the device 52 etc.) extracted from the image 34 may be superposed on the image 56.

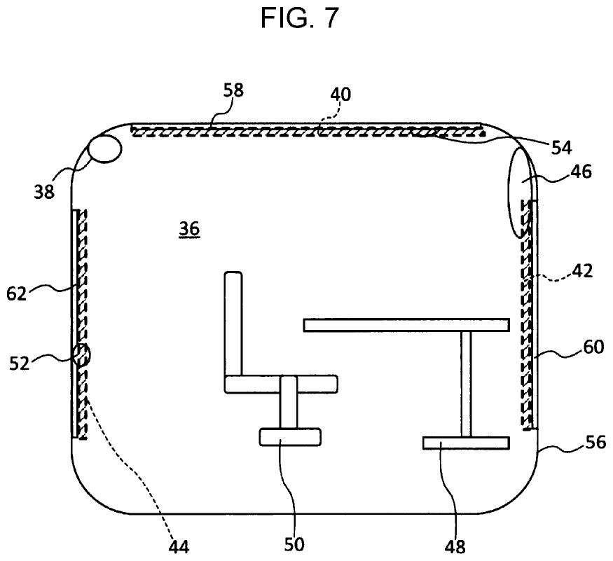

FIG. 7 illustrates a state in which the first image and the second image are superposed on each other. Here, by way of example, the second image which represents an existing object (e.g. the device 52 etc.) extracted from the image 34 is displayed as superposed on the present image 56. The wallpaper 40, 42, and 44 has been replaced with the wallpaper 58, 60, and 62, and previous images of the wallpaper 40, 42, and 44 are also displayed as superposed on the present image 56. In FIG. 7, previous images (i.e. images of wallpaper represented in the image 34) of the wallpaper 40, 42, and 44 are indicated by the broken lines, and the present images (i.e. images of wallpaper represented in the image 56) of the wallpaper 58, 60, and 62 are indicated by the solid lines. The second image which represents a different existing object (e.g. the device 52 etc.) extracted from the image 34 is also displayed as superposed on the image 56 in the same manner.

The second image may be a semi-transparent image, or may be an image in which only the contour of an existing object is represented, for example.

In the example illustrated in FIGS. 5 to 7, no existing objects other than the wallpaper have been changed. Therefore, as illustrated in FIG. 7, the present device 52 is represented in the image 56, and an image of the device 52 extracted from the previous image 34 is also displayed as superposed on the image 56. The same also applies to the other existing objects.

The processor 32 displays, on the present image 56, a previous image of the device 52 extracted from the previous image 34 at a position corresponding to the position at which the device 52 was disposed at the location α. The position of the device 52 may be a relative position from a reference object, or may be a position specified by the GPS etc., for example. For example, in the case where the clock 46 is designated as the reference object, the processor 32 specifies the position at which a previous image of the device 52 is to be displayed with reference to the position of the clock 46 which is represented in the image 56, and displays a previous image of the device 52 at the specified position. The same also applies to the other existing objects.

The processor 32 causes the display to display a previous image of each existing object as superposed on the captured present image 56 by applying the AR technology or the MR technology, for example.

The second image is displayed as superposed on the image 56 even if the device 52 is covered with the wallpaper 62 etc. and not seeable from the outside at the time point when the image 56 is captured.

All the previous image 34 may be disposed as superposed on the present image 56. In this case, an image that represents the background etc. other than the existing objects is also displayed as superposed on the image 56. Also in this case, the image 34 may be a semi-transparent image.

The processor 32 may cause the display to display the remarks information etc. which is registered in the image database as superposed on the present image 56. For example, a character string saying “The device 52 is installed five meters to the back from and under the clock 46” or a character string saying “The device 54 is installed 30 centimeters to the oblique upper left from the clock 46” may be displayed as superposed on the image 56. In addition, the processor 32 may cause the display to display information that indicates the function, the performance, etc. of each existing object as superposed on the present image 56. For example, information that indicates the function, the performance, etc. of the device 52 is displayed in connection with an image of the device 52.

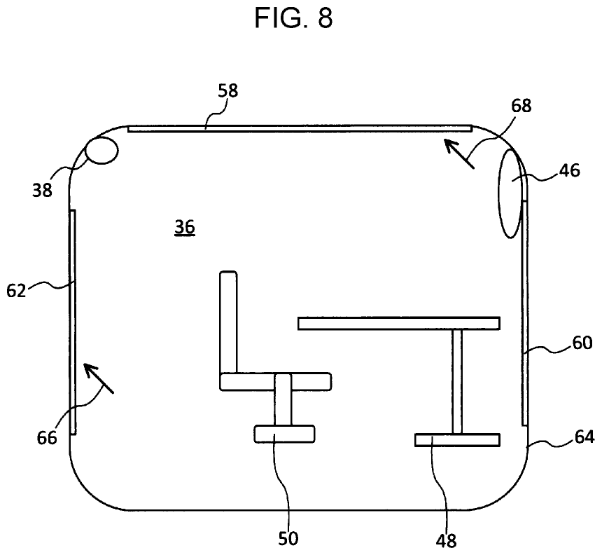

FIG. 8 illustrates a different display example. In the example illustrated in FIG. 8, the second image is an image that provides guidance on an existing object. For example, the second image is an image of an arrow etc. that indicates an existing object.

FIG. 8 illustrates an image 64 that represents the present situation at the location α. For example, the present image 64 is an image generated by capturing the location α, as with the image 56 described above.

Here, by way of example, the devices 52 and 54 are not represented in the present image 64. For example, the device 52 is covered with the wallpaper 62, and the device 54 is covered with the wallpaper 58. Therefore, the devices 52 and 54 are not visually recognizable, and the devices 52 and 54 are not represented in the image 64. As a matter of course, the devices 52 and 54 may not be covered with wallpaper, and the devices 52 and 54 may be represented in the present image 64, as in the example illustrated in FIG. 6.

An image 66 in FIG. 8 is an image of an arrow that indicates the device 52. An image 68 is an image of an arrow that indicates the device 54. The images 66 and 68 are examples of the second image.

The processor 32 causes the display to display the images 66 and 68 of arrows as superposed on the captured present image 68 by applying the AR technology or the MR technology, for example. For example, the processor 32 specifies the position of the device 52 on the image 68 with reference to the position of the clock 46 which is a reference object represented in the image 68, and displays the image 66 which indicates the specified position. The same also applies to the other existing objects.

The processor 32 may cause the display to display an image that indicates an existing object designated by the user as superposed on the present image 68. In the example illustrated in FIG. 8, the devices 52 and 54 are designated by the user, and the processor 32 displays the image 66 which indicates the device 52 and the image 68 which indicates the device 54. For example, a list of existing objects registered in the image database is displayed on the display of the terminal apparatus 14. When the user designates an existing object from the list, an image that indicates the designated existing object is displayed as superposed on the present image 68.

In the example illustrated in FIG. 8, an image of an arrow is displayed. However, a previous image that represents an existing object (e.g. the device 52 or 54) itself may be displayed together with or in place of an image of an arrow.

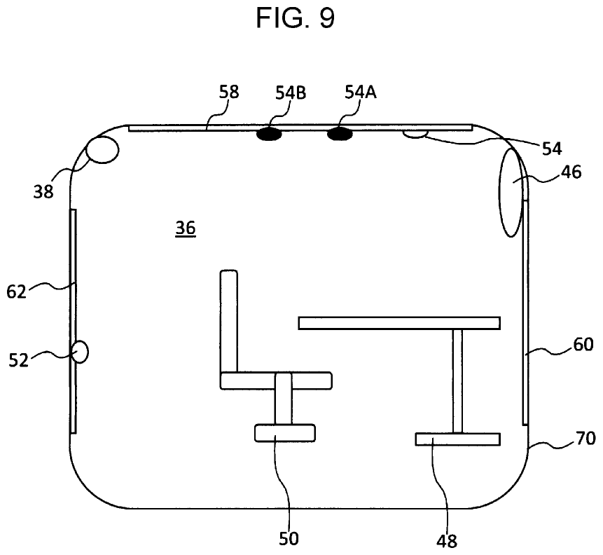

The processor 32 may cause the display to display the second image of an existing object at a first previous time point and the second image of the existing object at a second previous time point as superposed on the present first image. The second time point is different from the first time point. That is, the second images of the existing object at a plurality of previous time points may be displayed as superposed on the present first image. This display example will be described below with reference to FIG. 9. FIG. 9 illustrates a state in which the first image and the second image are superposed on each other.

An image 70 illustrated in FIG. 9 is an image that represents the present situation at the location α, and is an image generated by capturing the location α, as with the image 56 described above, for example.

In the example illustrated in FIG. 9, the present image of the device 54 is represented in the image 70. In addition, images 54A and 54B are represented in the image 70. The image 54A is an image that represents the device 54 at the first previous time point. The image 54B is an image that represents the device 54 at the second previous time point. The device 54 is installed at different locations at each of the present time point, the first time point, and the second time point. Thus, the present image of the device 54 and the images 54A and 54B are displayed at different positions in the image 70.

In addition, the processor 32 may cause the display to display the second image of an existing object at a time point designated by the user as superposed on the present image 70. For example, a list of dates and times registered in the image database for the location α may be displayed on the display of the terminal apparatus 14, and the processor 32 may cause the display to display the second image which is extracted from an image obtained on the date and time designated by the user from the list (e.g. an image captured on the designated date and time) as superposed on the present image 70. In another example, the processor 32 may cause the display to display the second image which is obtained from the most recent image, the second image which is obtained from the oldest image, or the second image which is obtained from a previous image that meets other conditions as superposed on the present image 70.

In the exemplary embodiment described above, the processor 32 may cause the display to display the second image as superposed on the first image in the case where the present situation of an object is varied from a previous situation of the object.

For example, the processor 32 compares the present image (i.e. the first image) and a previous image registered in the image database, and causes the display to display the second image as superposed on the first image in the case where there is a difference of a threshold or more between the two images.

This process will be described in detail with reference to FIGS. 5 and 8. At a certain previous time point (i.e. the time point when the image 34 was captured), as illustrated in FIG. 5, the devices 52 and 54 were not covered with wallpaper, and were visually recognizable from the outside. On the other hand, at present (i.e. the time point when the image 64 is captured), as illustrated in FIG. 8, the devices 52 and 54 are covered with wallpaper, and are not visually recognizable from the outside.

The processor 32 compares the present image 64 and the previous image 34, and causes the display to display the second image (e.g. images that represent the devices 52 and 54 themselves, images of arrows that indicate the installation positions of the devices 52 and 54, etc.) as superposed on the image 64 in the case where there is a difference of a threshold or more between the two images. The processor 32 causes the display to display the image 64 without superposing the second image on the image 64 in the case where the difference between the two images is less than the threshold.

The processor 32 may cause the display to display the second image as superposed on the present first image in the case where the reference object which has not been varied from a previous time point is captured.

This process will be described with reference to FIGS. 5 and 6. For example, the clock 46 is determined as the reference object. As illustrated in FIG. 5, the clock 46 is represented in the previous image 34. As illustrated in FIG. 6, the clock 46 is represented also in the present image 64. In the case where the clock 46 is represented in the captured present image 64 in this manner, the processor 32 causes the display to display the second image (e.g. an image that represents an existing object itself, an image of an arrow that indicates the installation position of the existing object, etc.) as superposed on the present image 64.

In addition, the processor 32 may calculate, on the basis of the position of each existing object represented in the present image 64, the relative positional relationship between the clock 46 and a different existing object, and calculate the relative positional relationship between the clock 46 and the different existing object on the basis of the position of each existing object represented in the previous image 34. The processor 32 may cause the display to display the second image as superposed on the present image 64 in the case where the difference between the present relative positional relationship and the previous relative positional relationship is a threshold or less.

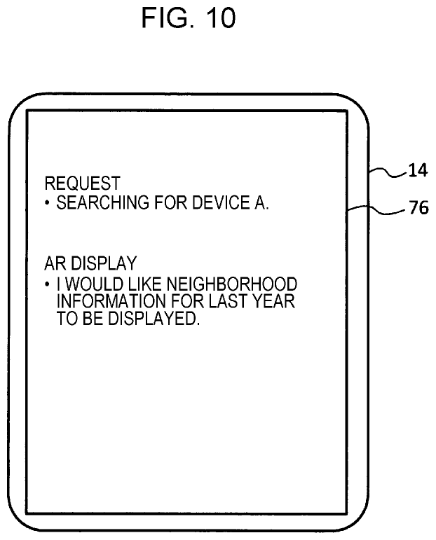

A user interface for providing an instruction to display a previous image will be described below with reference to FIG. 10. FIG. 10 illustrates a screen 76 displayed on the terminal apparatus 14. The user may provide an instruction to display a previous image on the screen 76.

For example, the screen 76 is provided with a field for inputting a request from the user. For example, the name of an object that the user is looking for etc. is input to the field. In the example illustrated in FIG. 10, a character string “device A” which indicates the name of a device is input by the user. The input information is transmitted from the terminal apparatus 14 to the information processing apparatus 10. The processor 22 of the information processing apparatus 10 retrieves a previous image of the device A as an existing object from the image database, and transmits the retrieved previous image to the terminal apparatus 14. The previous image is displayed on the display of the terminal apparatus 14. In the case where a present image is captured by the camera 28 of the terminal apparatus 14, for example, the previous image of the device A is displayed as superposed on the present image.

In addition, a previous time point may be designated by the user on the screen 76. In the example illustrated in FIG. 10, “last year” is designated as a previous time point. In this case, the processor 22 of the information processing apparatus 10 retrieves images captured last year from the image database, and transmits the retrieved images captured last year to the terminal apparatus 14. In the case where the user is at the location α, for example, images captured at the location α last year are retrieved, and the images captured last year are displayed on the display of the terminal apparatus 14. In the case where a present image at the location α is captured by the camera 28 of the terminal apparatus 14, the previous image is displayed as superposed on the present image. For example, an image of the device A captured last year is displayed as superposed on the present image.

Various information input on the screen 76 may be input through a voice. In this case, the screen 76 may not be displayed.

### Process Performed in Case Object is Image

A process performed in the case where the object is an image will be described below.

In the case where the object is an image, the first image is the present image displayed on the display, and the second image is an image displayed on the display at a previous time point. For example, the second image is an image related to an operation displayed on the display at a previous time point.

Examples of the first image and the second image include an operation screen, an icon, and other images. Examples of the operation screen include an operation screen (e.g. a desktop screen of an operating system (OS), operation screens of various application software, etc.) displayed on a display of a device such as a PC or a smartphone and an operation screen of other devices.

For example, the first image is the present operation screen, and the second image is an icon displayed on the operation screen. The icon as the second image is displayed at a position at which the icon was previously displayed on the present operation screen.

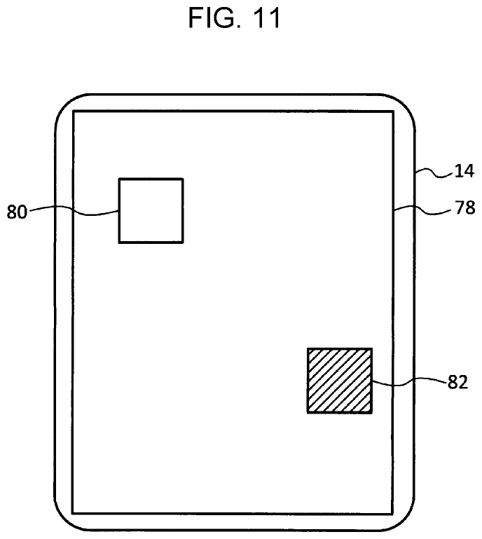

The process performed in the case where the object is an image will be described in detail below with reference to FIG. 11. FIG. 11 illustrates a screen 78 displayed on the display of the terminal apparatus 14. The image 78 is the present desktop screen of the OS, for example, and is an example of the first image. An icon 80 is displayed on the screen 78. The icon 80 may be an image connected with specific application software, or may be an image connected with specific data (e.g. image data, document data, etc.), for example. The icon 80 is an image displayed on the present desktop screen.

For example, when the user provides an instruction to display a previous desktop screen as superposed on the present desktop screen by operating the terminal apparatus 14, the processor 32 of the terminal apparatus 14 causes the display to display the previous desktop screen as superposed on the screen 78. For example, an icon 82 is the same as the present icon 80, and is the second image displayed on the previous desktop screen. The icon 82 is displayed at a position at which the icon 82 was displayed on the previous desktop screen on the present image 78. At the previous time point, the icon 80 was displayed at the display position of the icon 82. The processor 32 may make the mode of display of the icon 82 different from the mode of display of the icon 80. For example, the processor 32 may display the icon 82 such that the color of the previous icon 82 is different from the color of the present icon 80, may display the icon 82 such that the previous icon 82 is semi-transparent, or may display the icon 82 such that the shape of the previous icon 82 is different from the shape of the present icon 80.

For example, the memory 30 of the terminal apparatus 14 stores information related to a previous desktop screen (e.g. information for identifying an icon displayed on the previous desktop screen, information that indicates the position at which the icon was displayed, etc.). For example, information related to the desktop screen may be stored at intervals of a time determined in advance, or information related to the desktop screen before being varied may be stored in the case where the desktop screen has been varied (e.g. in the case where the position of an icon has been changed, in the case where an icon has been deleted or added, etc.), or information related to the desktop screen at the time when the user provides an instruction to store the desktop screen may be stored in the case where such an instruction is provided.

In the case where information related to the desktop screen at a plurality of previous time points is stored, the processor 32 may display icons displayed at the time points on the present image 78, or may display an icon displayed at a time point designated by the user on the present image 78.

The previous icon 82 may be an icon that is operable by the user, or may be an icon that is not be operable by the user. For example, application software connected with the previous icon 82 may be started in the case where the user presses the icon 82.

In addition, the processor 32 may display the icon 80 at a previous display position (i.e. the display position of the icon 82), rather than displaying the icon 80 at the present display position, in the case where the user selects setting for previous display by operating the terminal apparatus 14.

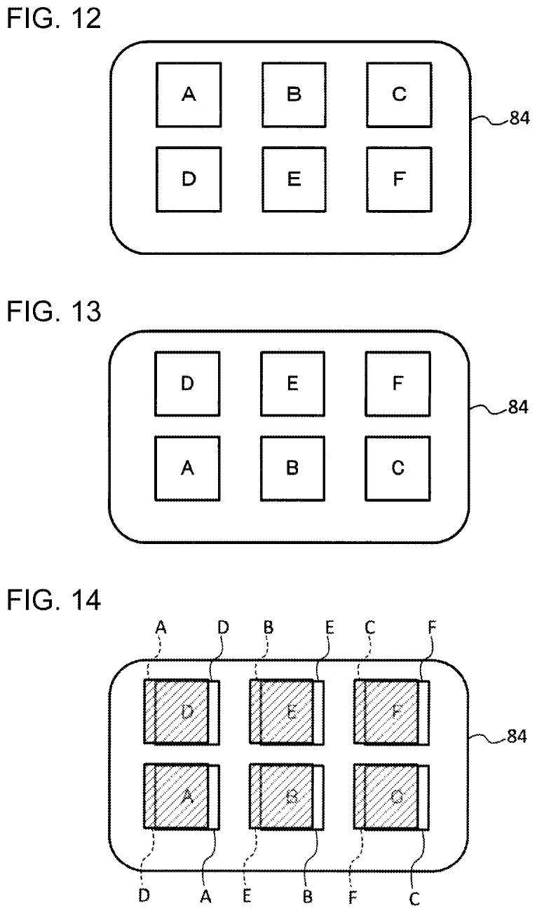

A different screen will be described below with reference to FIGS. 12 to 14. FIGS. 12 to 14 illustrate a screen 84 displayed on a display of a certain device. The screen 84 is a menu screen to be displayed on an operation panel of a multi-function device, for example. The screen 84 displays buttons A, B, C, D, E, and F to which respective functions are assigned. When a multi-function device is taken as an example, functions such as print and scan are assigned to the buttons. The user may change settings of the screen 84. For example, the user may change the display positions of the buttons displayed on the screen 84.

FIG. 12 illustrates the screen 84 at a previous time point. FIG. 13 illustrates the screen 84 at the present time point. At the present time point, the display positions of the buttons have been changed from the display positions thereof at the previous time point.

When the user provides an instruction to display the present screen and the previous screen as superposed on each other, for example, the processor of the device displays the buttons at the present display positions, and displays the buttons at the previous display positions, on the screen 84 as illustrated in FIG. 14. The processor may display the buttons at shifted display positions so as not to be completely superposed on each other, or may make the mode of display of the buttons displayed at the previous display positions different from the mode of display of the buttons displayed at the present display positions.

The processor may display the buttons at the previous display positions as illustrated in FIG. 12, rather than displaying the buttons at the present display positions, in the case where the user selects setting for the previous screen.

The screens illustrated in FIGS. 11 to 14 are merely exemplary, and the process described above may be applied to a setting screen for making various settings etc.

In addition, when the version of an OS or application software is changed, the processor of the device in which the OS or the application software is installed may display a screen related to the OS or the application software of the present version on the display, and display a screen related to the OS or the application software of the previous version on the display as superposed on the present screen.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
cause a display to display a first image that represents a present situation with a second image related to an object in a previous situation as superposed on the first image.

2. The information processing apparatus according to claim 1,
wherein the processor is configured to
display the second image as superposed on the first image in a case where the present situation of the object is varied from the previous situation of the object.

3. The information processing apparatus according to claim 1,
wherein the first image is an image that represents the present situation in a space,
the object is a substance, and
the second image is an image related to the substance which was disposed in the space at a previous time point.

4. The information processing apparatus according to claim 2,
wherein the first image is an image that represents the present situation in a space,
the object is a substance, and
the second image is an image related to the substance which was disposed in the space at a previous time point.

5. The information processing apparatus according to claim 3,
wherein the processor is configured to
display the second image on the first image at a position corresponding to a position at which the substance was disposed in the space.

6. The information processing apparatus according to claim 4,
wherein the processor is configured to
display the second image on the first image at a position corresponding to a position at which the substance was disposed in the space.

7. The information processing apparatus according to claim 3,
wherein the second image is an image that represents the substance.

8. The information processing apparatus according to claim 4,
wherein the second image is an image that represents the substance.

9. The information processing apparatus according to claim 5,
wherein the second image is an image that represents the substance.

10. The information processing apparatus according to claim 6,
wherein the second image is an image that represents the substance.

11. The information processing apparatus according to claim 3,
wherein the second image is an image that provides guidance on the substance.

12. The information processing apparatus according to claim 3,
wherein the first image is an image generated by capturing a scene in the space.

13. The information processing apparatus according to claim 12,
wherein the processor is configured to
display the second image as superposed on the first image in a case where a reference object is captured in the space, the reference object being not varied since a previous time point.

14. The information processing apparatus according to claim 3,
wherein the second image is an image obtained from an image generated by capturing a scene in the space at a previous time point.

15. The information processing apparatus according to claim 3,
wherein the processor is configured to
display the second image in a case where a request to display an image related to the substance is received from a user.

16. The information processing apparatus according to claim 3,
wherein the processor is configured to
display the second image related to the substance at a first previous time point and the second image related to the substance at a second previous time point as superposed on the first image.

17. The information processing apparatus according to claim 1,
wherein the first image is a present image displayed on the display, and
the second image is an image displayed on the display at a previous time point.

18. The information processing apparatus according to claim 17,
wherein the second image is an image related to an operation and displayed on the display at the previous time point.

19. The information processing apparatus according to claim 17,
wherein the second image is an icon which is the object, and
the processor is configured to
display the second image at a position at which the second image was previously displayed on the first image.

20. A non-transitory computer readable medium storing a program causing a computer to execute a process comprising
causing a display to display a second image related to an object in a previous situation as superposed on a first image that represents a present situation.
